(19) United States
(12) Patent Application Publication
(10) Pub. No.: US 2008/0313228 A1
(43) Pub. Date: Dec. 18, 2008

(54) CONTROLLER LOG AND LOG AGGREGATION

(75) Inventors: Daniel W. Clark, Lakewood, OH (US); David A. Johnston, Mentor, OH (US); James J. Kay, Chardon, OH (US); Bradley A. Lafuse, Willowick, OH (US); Stuart B. Siegel, Mentor, OH (US)

Correspondence Address: AMIN TUROCY & CALVIN, LLP;ATTENTION: HEATHER HOLMES, 127 Public Square, 57th Floor, Key Tower, Cleveland, OH, 44114, US

(73) Assignee: ROCKWELL AUTOMATION TECHNOLOGIES, INC., Mayfield Heights, OH (US)

(21) Appl. No.: 11/847,323

(22) Filed: Aug. 29, 2007

Related U.S. Application Data
(60) Provisional application No. 60/944,240, filed on Jun. 15, 2007.

(51) Int. Cl. G06F 17/30

(52) U.S. Cl. 707/104.1; 707/E17.001

(57) ABSTRACT

Systems and methods of recording user actions on an industrial controller. When a user logs into an industrial controller (e.g., a stand-alone controller) changes made to the controller can be recorded by a logging component. The recorded information can be encrypted to ensure reliability of the information. The logging component can be periodically brought into communication with an aggregation component which can receive log entries from a plurality of controllers and their associated logging components, and compile the log entries into an aggregate log.

### CROSS REFERENCE

This application claims the benefit of U.S. Provisional Patent Application Ser. No. 60/944,240 filed on Jun. 15, 2007, entitled “CONTROLLER LOG AND LOG AGGREGATION,” the entirety of which is incorporated herein by reference.

### BACKGROUND

Manufacturers typically require collection, analysis, and optimization of real time data from a plurality of sites that are located globally. One common solution for recording such data includes providing a local recording module that often occupies a slot in a controller backplane such as a PC-Historian. A particular and common solution for recording data includes a PC-Historian which is an industrial computer for the controller backplane, and employs a transitional layer to supply an indirect interface to the controller. This includes a platform that provides high speed, time series, data storage and retrieval with both local and remote control processors. The PC-Historian communicates with controllers directly through the backplane and can communicate remotely via a network interface. The PC-Historian allows archiving data from the controller to an Archive Engine which provides additional storage capabilities.

Typically, such controllers are special-purpose computers utilized for controlling industrial processes, manufacturing equipment, and other factory automation, such as data collection or networked systems. At the core of the industrial control system, is a logic processor such as a Programmable Logic Controller (PLC) or PC-based controller. Programmable Logic Controllers for instance, are programmed by systems designers to operate manufacturing processes via user-designed logic programs or user programs. The user programs are stored in memory and generally executed by the PLC in a sequential manner although instruction jumping, looping and interrupt routines, for example, are also common. Associated with the user program are a plurality of memory elements or variables that provide dynamics to PLC operations and programs. Differences in PLCs are typically dependent on the number of Input/Output (I/O) they can process, amount of memory, number and type of instructions, and speed of the PLC central processing unit (CPU).

An industrial controller can be customized to a particular process by writing one or more control software routines that may be stored in the controller's memory and/or by changing the hardware configuration of the controller to match the control task or strategy. Such control routines may be generated using controller configurations systems or tools, which facilitate translation of a desired control strategy for the process into a control routine executable in a controller. For example, configuration tools can provide for graphical representations of control functions known as function blocks. A user models a control strategy by placing function blocks in a user interface work surface, and associating the function blocks using graphical connections known as wires, via a graphical user interface. Once the user has thus defined the desired control strategy, the configuration system compiles or verifies the graphical representation to produce a control routine, which may then be downloaded to one or more control modules in the control system. The control functions represented by the function blocks are implemented in the verified control routine according to execution ordering which may be determined in the compilation or verification process in the configuration tool.

Controllers and associated I/O modules can typically generate a significant amount of data relating to industrial processes. For example, controllers output status of sensors, drives, actuators, and the like. Recent market and technological factors have caused many industries to rely purely on a network connection and a central recording system that requires a persistent network connection. However, not all controllers are continuously connected to a network. While there are typically mechanisms in place to record data relating to the operation of a controller or group of controllers, users can and do frequently make changes to settings of a controller, which are not recorded or logged. Many controllers are not configured to record the identity of the initiator of the changes and therefore a knowledgeable operator can make changes to a controller and leave no trace behind. If the changes cause an error, a problem, or a failure, there is no way to determine who performed which actions on the controller.

### SUMMARY

The following presents a simplified summary of the invention in order to provide a basic understanding of some aspects of the innovation. This summary is not an extensive overview of the innovation. It is intended to neither identify key or critical elements of the innovation nor delineate the scope of the innovation. Its sole purpose is to present some concepts of the innovation in a simplified form as a prelude to the more detailed description that is presented later.

The subject innovation records changes made to a controller (e.g., controllers that are periodically connected to the network) via a logging component and supplies such changes to an administrator upon occurrence of a predetermined event, such as upon connection to a network. While many controllers maintain a persistent network connection to supporting mechanisms, not all industrial operations are so connected—some controllers are brought into communication with other components at irregular intervals only. The subject innovation enables a controller or group of controllers to transfer information to supporting mechanisms for oversight and review despite a discontinuous network connection. The subject innovation allows programmatic detection of modifications to a controller at run time. Also, employing the systems and methods disclosed herein allows the monitored equipment to be shut down to a safe state if and when any modifications occur; the logging capabilities of the subject disclosure allow recordation of settings and any changes, to facilitate such shut down.

In a related aspect, an aggregation component associated with the industrial process receives the logged information from the controller or group of controllers when the controllers are brought into communication with the aggregation component. The logging component can employ an identity component to record the user's identity and other circumstantial information such as location, status, permission level, and the like. Such logging can comprise contextual data relating to any aspect of an industrial process. A security component can protect the logged information from compromise (e.g., by encryption, reporting of attempts to access or alter the data) so as to ensure reliable data. In an aspect, the information can be used in a post hoc investigation to assess liability, warranty validity, or merely to improve operation of a plant, and so the logged information can prove invaluable—but only so far as the information has avoided tampering.

In an aspect, the log resides on the controller and can typically mitigate a requirement of external devices or hardware to create and distribute the logged information. Periodically, the logging component can communicate the information to an aggregation component that can receive information from a plurality of logging components associated with a plurality of controllers. The aggregation component can compile an aggregate log containing information from the plurality of controllers and their associated logging components, and re-order the log entries to describe the events of the plurality of controllers in a central aggregate log.

According to a further aspect, a plurality of methodologies can be employed to trigger transfer of information from the memory to the logging component. Such can include transferring information if local memory reaches a certain threshold capacity, if the user issues a command, or if a predetermined event that merits recording is detected. The information recorded can include user events as well as non-user events (e.g., machine self-diagnosis).

According to a related methodology, while operating with or without a persistent network connection, the controller can receive alteration commands from a user. The alterations and related information such as user identity, user location, user permissions, and the like, can be recorded in the controller's local memory. The information can be recorded by the logging component if requested by a user, if the local memory reaches a predetermined capacity (e.g., 60%, 70%), or if a predetermined event (e.g., pre-defined thresholds, manipulation of sensitive data, alterations made without supervision) is detected. Periodically the controller can be brought into communication with an aggregation component to transfer the logged information to the aggregation component, which can receive logged information from a plurality of controllers. The logged information can comprise a plurality of log entries which can include such information as a timestamp, which can be used to synchronize the log entries and create an aggregate log.

To the accomplishment of the foregoing and related ends, the invention then, comprises the features hereinafter fully described and particularly pointed out in the claims. The following description and the annexed drawings set forth in detail certain illustrative aspects of the innovation. These aspects are indicative, however, of but a few of the various ways in which the principles of the innovation may be employed; the subject innovation is intended to include all such aspects and their equivalents. Other objects, advantages, and novel features of the innovation will become apparent from the following detailed description of the innovation when considered in conjunction with the drawings.

### BRIEF DESCRIPTION OF THE DRAWINGS

FIG. 1 illustrates an exemplary block diagram of a system that logs user and non-user events, and communicating the information to a workstation.

FIG. 2 depicts an aspect of further operation of a logging component including an identity component, a tolerance component, an artificial intelligence component and a security component.

FIG. 3 illustrates a particular block diagram depicting a system that aggregates logged information from several controllers and their logs.

FIG. 4 illustrates an embedded historian component as part of an industrial operation in accordance with an aspect of the subject innovation.

FIG. 5 depicts an exemplary block diagram illustrating further operation of an aggregation component that can receive a plurality of logs and create an aggregate log.

FIG. 6 is an exemplary flow chart diagram of a methodology that enables recording events to a log.

FIG. 7 is an illustrative flow chart diagram of a methodology that permits alterations, timestamp information, identity information and the like to be logged and uploaded for central storage and aggregation.

FIG. 8 depicts an exemplary methodology that facilitates log aggregation without sacrificing independence of logged information.

FIG. 9 illustrates an exemplary environment where various aspects of the subject innovation can be implemented.

FIG. 10 illustrates a further exemplary environment wherein aspects of the innovation can be implemented.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

As used in this application, the terms “component” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity. Furthermore, all or portions of the subject innovation may be implemented as a method, apparatus or article of manufacture using standard programming and/or engineering techniques to produce software, firmware, hardware, or any combination thereof to control a computer to implement the disclosed innovation.

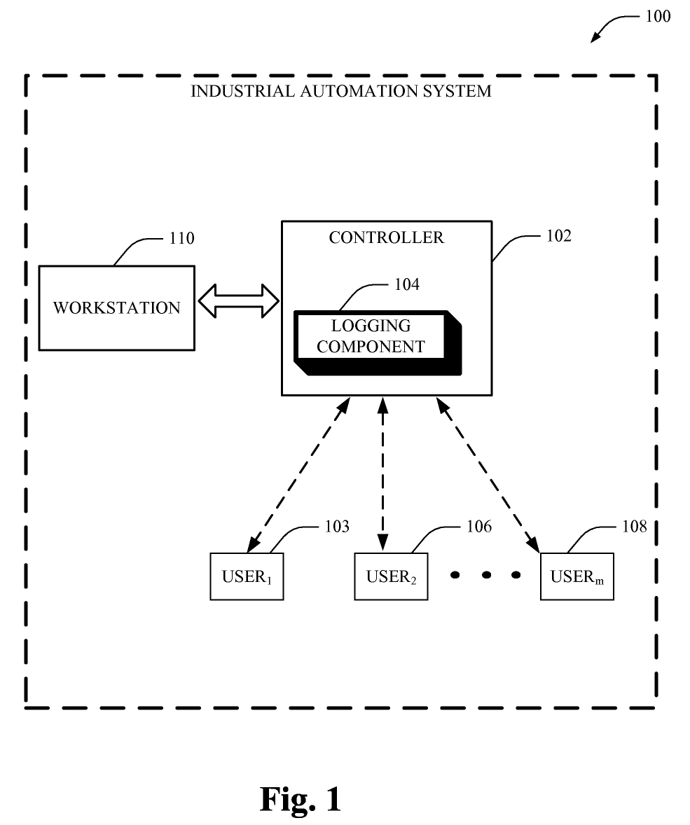

FIG. 1 illustrates an en exemplary system 100 that records operator actions performed on a controller 102 (e.g., regardless of whether the controller 102 is connected to a network). The controller 102 can be any type of industrial controller, which can contain a logging component 104 for recording information. The logged information can relate to general operation of the controller 102, and also to user defined settings such as a gain value. Controllers, with their ability to receive almost any type of instruction, offer an enormous degree of flexibility. Unless strict protocols are employed (as is generally not the case), the values in the control routines executing on the controller are not tightly integrated with security, allowing a malicious or incompetent user to readily make changes to the control routines without leaving a trace of his action. Given the highly sensitive nature of the control logic values, and the high potential for damage in the event of a failure or malfunction, this is not a desirable situation.

The logging component 104 can serve as a data store for the controller 102 that can employ volatile memory or nonvolatile memory, or a combination thereof. In one example, nonvolatile memory can include read only memory (ROM), programmable ROM (PROM), electrically programmable ROM (EPROM), electrically erasable ROM (EEPROM), or flash memory. The memory can include removable memory such as Compact Flash cards, Secure Digital cards, and the like. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The data store of the subject systems and methods is intended to comprise, without being limited to, these and any other suitable types of memory.

In a related aspect, the logging component 104 can employ an internal flash storage device which can be integral to the controller 102. Accordingly, the system can act in a controller-centric fashion. It is to be appreciated, however, that in alternative aspects a logging component 104 can be stored externally or employ removable storage. Removable storage can be used to perform offsite or remote review of the information stored by the logging component 104 on a scheduled basis, or if circumstances so require. Removal and review can be performed without requiring additional network infrastructure and can enable an understanding of changes that occur over a period of time. The logging component 104 can record user modifications to any aspect of the system 100 and to the controller 102 such as a gain value, a PID loop, and the like.

The subject innovation can employ various methodologies to trigger the logging component 104 to record information; a small number of examples are given here for illustrative purposes. Before information is recorded by the logging component 104, it can be stored in local memory. When this temporary storage area reaches a predetermined level of capacity (e.g., 60%, 80%) the information can automatically be recorded by the logging component 104. Moreover, the logging component 104 can automatically record logged information before a controller firmware update in order to ensure that the logged information is associated with an appropriate firmware version, mitigating a need for backward compatibility. In one aspect, when the firmware is updated the local storage can be free from logged information that pertains to a previous firmware version, so logged information thereafter can correspond to the current firmware version. Also, a user 106 or 108 can send a command to the controller object at any time instructing the logging component 104 to record information. Any of these features can be enabled or disabled by the user; also, a default value can be specified either to perform a write, or to forebear if one or more of the above conditions is met.

It is to be appreciated that the logging component 104 of the subject innovation can record any type of data related to the industrial process (e.g., monitoring, quality control, process management, maintenance, firmware upgrades, and the like). The list of actions that can be recorded by the logging component 104 is virtually unlimited. The following indicates examples that can be recorded by the logging component 104, including examples of relevant data that can be captured along with each entry:

Project Download

Time Stamp = <time>
Entry Description = “Project download”
UserName = <username>
Workstation Name = <workstation name>
Factory Talk Login Id = <FT login id>
Extended Information = “Project <project_name>”

Load from removable media

Time Stamp = <time>
Entry Description = “Project load”
UserName = <username>
Workstation Name = <workstation name>
Factory Talk Login Id = <FT login id>
Extended Information = “Project <project_name>”

Load from removable media auto-initiated

Time Stamp = <time>
Entry Description = “Project auto load”
UserName = Local
Workstation Name = None
Factory Talk Login Id = None
Extended Information = “Project <project_name>”

Store to removable media

Time Stamp = <time>
Entry Description = “Project store”
UserName = <username>
Workstation Name = <workstation name>
Factory Talk Login Id = <FT login id>
Extended Information = “Project <project_name>”

Online edits tested or assembled

Time Stamp = <time>
Entry Description = “Online edits modified controller program”
UserName = <username>
Workstation Name = <workstation name>
Factory Talk Login Id = <FT login id>
Extended Information = “”

Edits logged are:
Test Program Edits
UnTest Program Edits
Assemble Program Edits
Accept Program Edits
Accept Pending Rung Edits

Partial Import Online Completed

Time Stamp = <time>
Entry Description = “Partial import online modified controller”
UserName = <username>
Workstation Name = <workstation name>
Factory Talk Login Id = <FT login id>
Extended Information = “”

I/O Forces enabled

Time Stamp = <time>
Entry Description = “I/O forces enabled”
UserName = <username>
Workstation Name = <workstation name>
Factory Talk Login Id = <FT login id>
Extended Information =””

I/O Forces disabled

Time Stamp = <time>
Entry Description = “I/O Forces Disabled”
UserName = <username>
Workstation Name = <workstation name>
Factory Talk Login Id = <FT login id>
Extended Information =””

I/O Forces Removed

Time Stamp = <time>
Entry Description = “I/O forces removed”
UserName = <username>
Workstation Name = <workstation name>
Factory Talk Login Id = <FT login id>
Extended Information =””

I/O Forces Modified

Time Stamp = <time>
Entry Description = “I/O force value changed”
UserName = <username>
Workstation Name = <workstation name>
Factory Talk Login Id = <FT login id>
Extended Information =”Tag: <Tag name>” (if available)

SFC Forces enabled

Time Stamp = <time>
Entry Description = “SFC forces enabled”
UserName = <username>
Workstation Name = <workstation name>
Factory Talk Login Id = <FT login id>
Extended Information =””

SFC Forces disabled

Time Stamp = <time>
Entry Description = “SFC forces disabled”
UserName = <username>
Workstation Name = <workstation name>
Factory Talk Login Id = <FT login id>
Extended Information =””

SFC Forces Removed

Time Stamp = <time>
Entry Description = “SFC forces removed”
UserName = <username>
Workstation Name = <workstation name>
Factory Talk Login Id = <FT login id>
Extended Information =””

SFC Forces Modified

Time Stamp = <time>
Entry Description = “SFC element force value changed”
UserName = <username>
Workstation Name = <workstation name>
Factory Talk Login Id = <FT login id>
Extended Information =”Routine: <SFC routine name>”

Firmware update from Work Station

Time Stamp = <time>
Entry Description = “Firmware update attempted”
UserName = None
Workstation Name = None
Factory Talk Login Id = None
Extended Information = “Old rev <major>.<minor>, New rev <major>.<minor>”

Major: 2 digit decimal format
Minor: 2 digit decimal format

Firmware update from removable media

Time Stamp = <time>
Entry Description = “Firmware update from removable media attempted”
UserName = Local
Workstation Name = None
Factory Talk Login Id = None
Extended Information = “Old rev <major>.<minor>, New rev <major>.<minor>”

Mode change started

Time Stamp = <time>
Entry Description = “Remote mode change”
UserName = <username>
Workstation Name = <workstation name>
Factory Talk Login Id = <FT login id>
Extended Information = “Old mode <mode>, New mode <mode>”

Possible Modes:
Run
Remote Run
Test
Program
Remote Program

Mode change started via key switch

Time Stamp = <time>
Entry Description = “Keyswitch mode change”
UserName = Local
Workstation Name = None
Factory Talk Login Id = None
Extended Information = “Old mode <mode>, New mode <mode>”

Major fault

Time Stamp = <time>
Entry Description = “A major fault occurred”
UserName = None
Workstation Name = None
Factory Talk Login Id = None
Extended Information = “Fault type <type>, Fault code<code>”

Fault Type: decimal
Fault Code: decimal

Major faults cleared

Time Stamp = <time>
Entry Description = “All major faults cleared”
UserName = <username>
Workstation Name = <workstation name>
Factory Talk Login Id = <FT login id>
Extended Information = “”

Major faults cleared through key switch

Time Stamp = <time>
Entry Description = “All major faults cleared”
UserName = Local
Workstation Name = None
Factory Talk Login Id = None
Extended Information = “”

Program Properties Modified

Time Stamp = <time>
Entry Description = “Program properties modified”
UserName = <username>
Workstation Name = <workstation name>
Factory Talk Login Id = <FT login id>
Extended Information = “Program <prog_name>”

Property changes logged:
Inhibit checkbox
Main Routine changed
Fault Routine changed

Task Properties Modified

Time Stamp = <time>
Entry Description = “Task properties modified”
UserName = <username>
Workstation Name = <workstation name>
Factory Talk Login Id = <FT login id>
Extended Information = “Task <task_name>”

Property changes logged:
Type changed
Inhibit checkbox
Watchdog value
Disable Automatic Output Processing to Reduce Task Overhead checkbox
Priority value
Period Value
Execute if no Event occurs within X ms check box
Trigger changed
Trigger Tag changed
Schedule changed/Unscheduled operation

Controller Timeslice Modified

Time Stamp = <time>
Entry Description = “Controller time slice modified”
UserName = <username>
Workstation Name = <workstation name>
Factory Talk Login Id = <FT login id>
Extended Information =””

Changes Logged:
System Overhead Time Slice
During unused System Overhead Time Slice radio buttons

Removable Media Removed

Time Stamp = <time>
Entry Description = “Removable media removed”
UserName = Local
Workstation Name = None
Factory Talk Login Id = None
Extended Information =””

Removable Media Inserted

Time Stamp = <time>
Entry Description = “Removable media inserted”
UserName = Local
Workstation Name = None
Factory Talk Login Id = None
Extended Information =””

Safety Signature Create

Time Stamp = <time>
Entry Description = “Safety signature created”
UserName = <username>
Workstation Name = <workstation name>
Factory Talk Login Id = <FT login id>
Extended Information =”Signature number: 0xYYYYYYYY” (hex format)

Safety Signature Delete

Time Stamp = <time>
Entry Description = “Safety signature deleted”
UserName = <username>
Workstation Name = <workstation name>
Factory Talk Login Id = <FT login id>
Extended Information =”Signature number: 0xYYYYYYYY” (hex format)

Safety Lock

Time Stamp = <time>
Entry Description = “Safety lock”
UserName = <username>
Workstation Name = <workstation name>
Factory Talk Login Id = <FT login id>
Extended Information =””

Safety Unlocked

Time Stamp = <time>
Entry Description = “Safety unlock”
UserName = <username>
Workstation Name = <workstation name>
Factory Talk Login Id = <FT login id>
Extended Information =””

Custom Entry

Time Stamp = <time>
Entry Description = <User supplied string>, max 40 characters
UserName = <username>
Workstation Name = <workstation name>
Factory Talk Login Id = <FT login id>
Extended Information = <User Supplied Info>, max 82 characters

According to a further aspect, User₁ 103 can make alterations to the controller 102, which can be recorded as described above by the logging component 104. User₁ 103 can also indicate that if any other user should attempt to make a change to a setting, action can be taken. User₁ 103 can be notified of the change, the change can be prevented, and/or the change can be recorded by the logging component 104. For example, the User₁ 103 configures controller 102, and asks to be notified of any changes made to a number of his settings. If and when a User₂ 106 (or any of a number of users Userₘ 108) attempts to make changes, the User₁ 103 can receive notification of the fact. The users can group settings, and dictate which actions are to be taken in response to attempts to alter or otherwise access settings in a group. User₁ 103 may wish to prevent any changes to some settings, or at least desire that any such changes are recorded by the logging component 104. In another aspect, the logging component 104 can record non-user events, such as self-diagnosis records that may be produced periodically by a machine related to the controller 102. By way of example, self-diagnosis equipment can be implemented to monitor a tool (e.g., a drill bit, lathe bit) for heat, wear, corrosion, and the like. If the tool begins to wear, or breaks, or any other detectable event occurs, the self-diagnosis equipment can record the event. According to this aspect, this information can be recorded by the logging component 104 along with the other user information and user-initiated changes made to the controller 102. In this way, a rich context of information can be included by the logging component 104.

The logging component 104 can communicate with a workstation 110 from time to time to facilitate access to the information on the log. The system 100 can be used in a smaller manufacturing plant with one (or few) stand-alone controller(s), with a limited amount of storage and periods of time without network connectivity. Periodically, the information stored by the logging component 104 can be retrieved by the workstation 110 and reviewed.

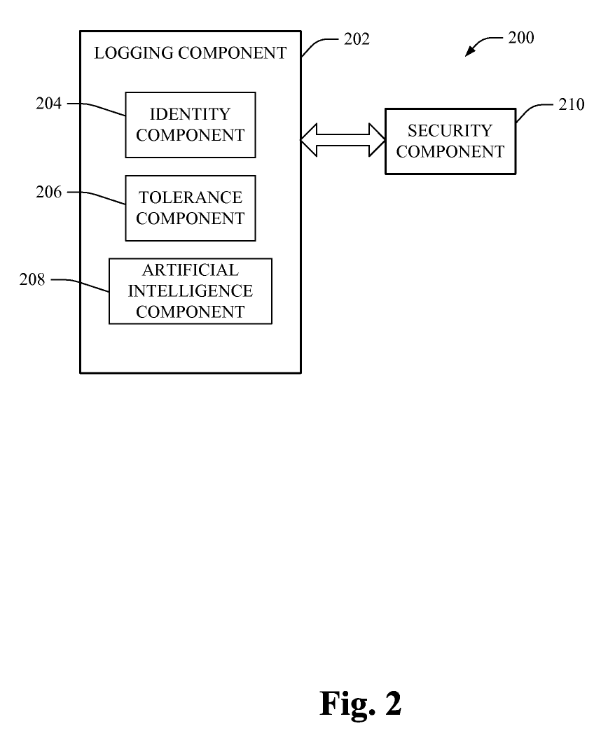

FIG. 2 illustrates a system 200 including further operation of a logging component 202 according to an aspect of the subject disclosure. As described above, the logging component 202 can record virtually any detectable event including modifications, adjustments, and other acts performed on the monitored equipment. In addition to the modifications, the identity of the user who initiated the modification can be recorded by an identity component 204. A user can comprise either a human operator, a machine operator, or a combination of a human operator and a machine, such as a scheduled change that is initiated by a human operator ahead of time. If a machine or other component is used as an intermediary between the user and the monitored equipment to effectuate alterations, the identity of both the intermediary machine and the user can be recorded. In addition, if a low-level employee may be given permission to act on behalf of a supervisor with higher permissions, both the status of the low-level employee and of the supervisor can be recorded. A user may authenticate (log in) to the monitored equipment (e.g., the controller monitored by the logging component as shown in FIG. 1), by entering a username and password at a terminal or other human machine interface, for example. The identity component 204 can record the user's identity, login time, position, as well as the user's status, including but not limited to level of authority (senior manager, new employee, and the like) and level of experience with the particular equipment involved. Virtually any information describing a user or other initiator of a detectable event can be recorded by the logging component 202, as facilitated by the identity component 204.

In accordance with another aspect, the logging component 202 can contain a tolerance component 206 that can employ a range check or tolerance to a given value in the controller (or other monitored equipment in which the logging component 202 is deployed), where if changes are made that exceed a range predetermined and known by the tolerance component 206, the logging component 202 can be triggered to record the event. Different values can have different impact on a manufacturing or industrial process, so accordingly the acceptable range can vary depending on context and an associated importance of the variable. Focusing the stored information to logged information thus deemed important, the tolerance component 206 can help minimize the amount of information collected/acquired by the logging component 202, easing post hoc investigations. The range of acceptable modification to a setting can vary as a function of a characteristic of a user attempting to change the setting, as indicated by the identity component 204. A high level manager or executive may be allowed to change values to a greater degree than someone with lower credentials or permissions. The system 200 can therefore record changes that are more likely to be suspect (e.g. performed by a less skilled/trusted individual). Also, the range can expand or contract as a function of the location of the user, which can also be recorded by the identity component 204. When a user logs into the monitored equipment, his location can be determined and used to adjust the range of acceptable change criteria. In certain contexts, a user standing in front of the monitored equipment can be given greater latitude than a remote user. This can also limit the effectiveness of an unauthorized assailant who will likely attack remotely via the internet or other networked environment. All these factors can be used in isolation or in combination to assess and apply a range within which the logging component 202 will not make an entry. In a related aspect, a user can be required to provide credentials accompanying modifications that exceed the range, even if the user has previously logged in to the terminal.

In an aspect of the subject innovation, an artificial intelligence component 208 can be employed to facilitate the range checking of control values and settings. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The range of acceptable changes that can be made before the logging component 202 records an entry can be varied by inference from a variety of factors. For example, factors such as user permissions and authority can be used to decide whether to record a given operation. A list of employees and their allowed actions can be maintained, but since controllers in general can be altered to such a great degree, the list is perhaps less than exhaustive. If a user attempts to make a change that is not on a list of permissible changes, but through an inference is deemed similar to a change that is on the list, the logging component 202 can record the change despite lacking explicit instructions to do so. In general, the artificial intelligence component 208 can be instructed to infer a likelihood that a piece of information would be valuable if recorded, and to direct the logging component to record the information if the likelihood is above a threshold.

Logging component 202 can employ a security component 210 to ensure reliability of logged information. Controllers regularly handle extremely valuable and sensitive equipment, and any delay or failure can potentially cost astronomical amounts of time and money. It can be therefore important to have a record of the circumstances surrounding a machine failure or problem. If a machinery operator with poor skill or judgment alters a controller and causes a problem, the information stored in the logging component 202 can become highly illuminating when it comes time to investigate the problem. To be valuable, the information should be protected from tampering. A company responsible for a catastrophic machine failure can face an incredible incentive to delete or modify log entries to escape liability; therefore, in an aspect of the subject innovation, the security component 210 can encrypt log entries. In addition, the security component 210 can also record attempts to access or modify the information. As shown here, the security component 210 resides externally to the logging component 202; however, the security component can reside within the logging component 202, and can integrate with other security measures employed with the monitored equipment.

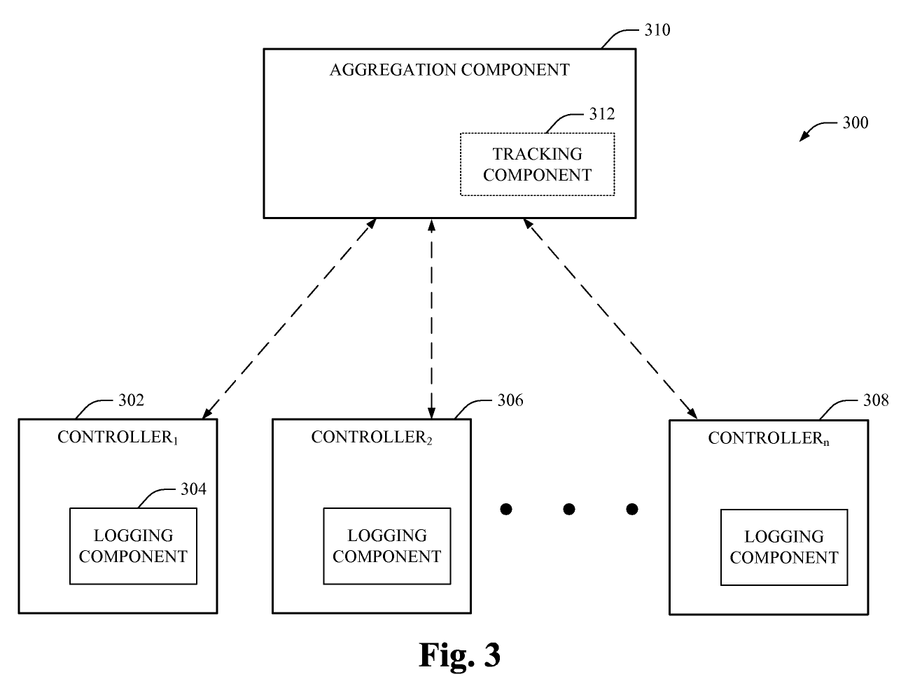

FIG. 3 depicts a system 300 for aggregating logged information. A controller 302 can contain a logging component 304, and operate in a substantially similar manner to the controller 102 depicted in FIG. 1. The controller 302 can be one of any number of controllers (e.g., controller₂ 306, controllerₙ 308) that comprise the system 300. The controllers can be configured to work together or individually. Aggregation component 310 can communicate with controller 302 and read and record information stored by logging component 304. The communication can take place over a network connection, or any other type of communication means. The connection need not be a persistent one; rather, the connection may be periodically enabled. In accordance with one aspect, controller 302 is a stand-alone controller, which can function for periods of time without establishing any form of connection to the aggregation component 310, or any other component within or without the system 300. When the controller 302 does come into communication with the aggregation component 310, the information recorded by the logging component 304 can be transferred to the aggregation component 310 for review.

According to an aspect, the aggregation component 310 can include a tracking component 312, which can receive information relating to changes made to a controller 302 and recorded by a logging component 304. The tracking component 312 can restore the altered setting to at least one previous state. The tracking component 312 is shown as part of the aggregation component 310, but it is to be appreciated that the logging component 304 can contain a tracking component 312.

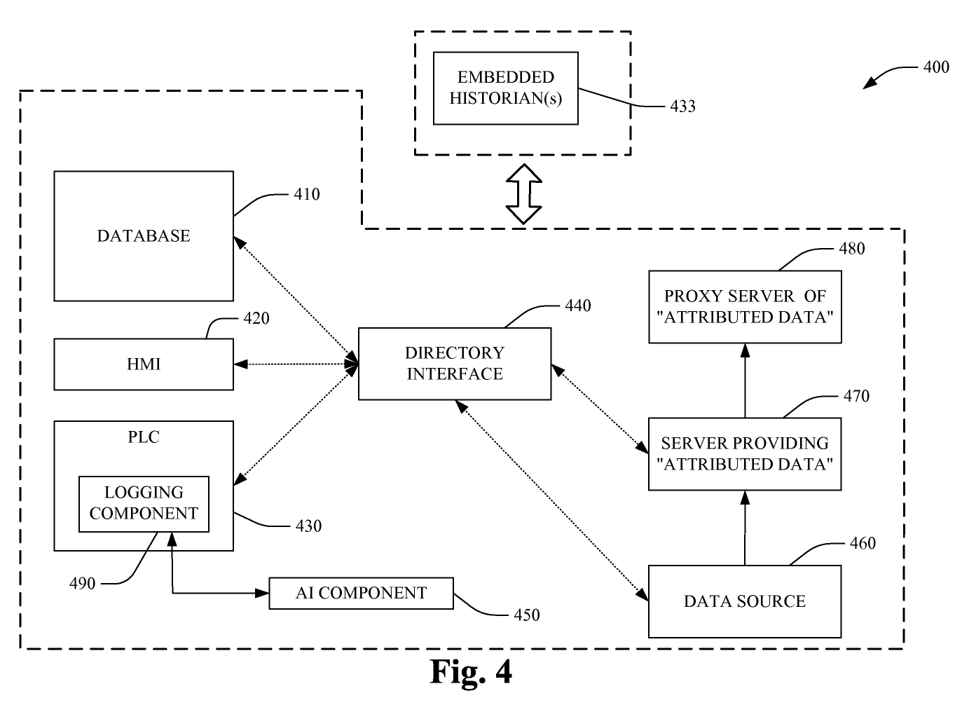

FIG. 4 illustrates an exemplary industrial automation network that employs a logging component 490 as part of a programmable logic controller (PLC) 430, which can further interact with an embedded historian component 433. As illustrated, the industrial setting 400 includes a database 410, a human machine interface (HMI) 420, the PLC 430, and a directory interface 440. The logging component 490 can further associate with an Artificial Intelligence (AI) component 450 to facilitate determination of logging/data collection.

For example, in connection with recording actions taken on a controller, the subject innovation can employ various artificial intelligence schemes. A process for learning explicitly or implicitly whether data from local memory should be recorded, can be facilitated via an automatic classification system and process. Classification can employ a probabilistic and/or statistical-based analysis (e.g., factoring into the analysis utilities and costs) to prognose or infer an action that a user desires to be automatically performed. For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information) so that the classifier is used to automatically determine according to a predetermined criteria which answer to return to a question. For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class). As shown in FIG. 4, an artificial intelligence (AI) component 450 can be employed to facilitate inferring and/or determining when, where, how to vary collection/log of data. The AI component 450 can employ any of a variety of suitable AI-based schemes as described supra in connection with facilitating various aspects of the subject innovation.

In addition, the directory interface 440 can be employed to provide data from an appropriate location such as the data source 460, a server 470 and/or a proxy server 480. Accordingly, the directory interface 440 can point to a source of data based upon role and requirements (needs) of a requester (e.g., database 410, HMI 420, PLC 430, and the like.) The database 410 can be any number of various types such as a relational, network, flat-file or hierarchical systems. Typically, such databases can be employed in connection with various enterprise resource planning (ERP) applications that can service any number of various business related processes within a company. For example, ERP applications can be related to human resources, budgeting, forecasting, purchasing and the like. In this regard, particular ERP applications may require data that has certain desired attributes associated therewith. Thus, in accordance with an aspect of the subject innovation, the directory interface 440 can provide data to the database 410 from the server 470, which provides data with the attributes desired by the database 410.

Moreover, the HMI 420 can employ the directory interface 440 to point to data located within the system 400. The HMI 420 can be employed to graphically display various aspects of a process, system, factory, etc. to provide a simplistic and/or user-friendly view of the system. Accordingly, various data points within a system can be displayed as graphical (e.g., bitmaps, jpegs, vector based graphics, clip art and the like) representations with desired color schemes, animation, and layout.

The HMI 420 can request data to have particular visualization attributes associated with data in order to easily display such data thereto. For example, the HMI 420 can query the directory interface 440 for a particular data point that has associated visualization attributes. The directory interface 440 can determine the proxy server 480 contains the attributed data point with the desired visualization attributes. For instance, the attributed data point can have a particular graphic that is either referenced or sent along with the data such that this graphic appears within the HMI environment instead of or along with the data value.

PLC 430 can be any number of models such as Allen Bradley PLC5, SLC-500, MicroLogix, ControlLogix, and the like. The PLC 430 is generally defined as a specialized device employed to provide high-speed, low-level control of a process and/or system. The PLC 430 can be programmed using ladder logic or some form of structured language. Typically, the PLC 430 can utilize data directly from a data source (e.g., data source 460) that can be a sensor, encoder, measurement sensor, switch, valve and the like. The data source 460 can provide data to a register in a PLC and such data can be stored in the PLC if desired. Additionally, data can be updated (e.g., based on a clock cycle) and/or output to other devices for further processing. In general, the embedded historian 433 (unlike conventional PC historians) can supply a direct interface to the PLC 430 without employing a transitional layer, and hence provide a substantially higher data exchange rate as compared to conventional PC historians.

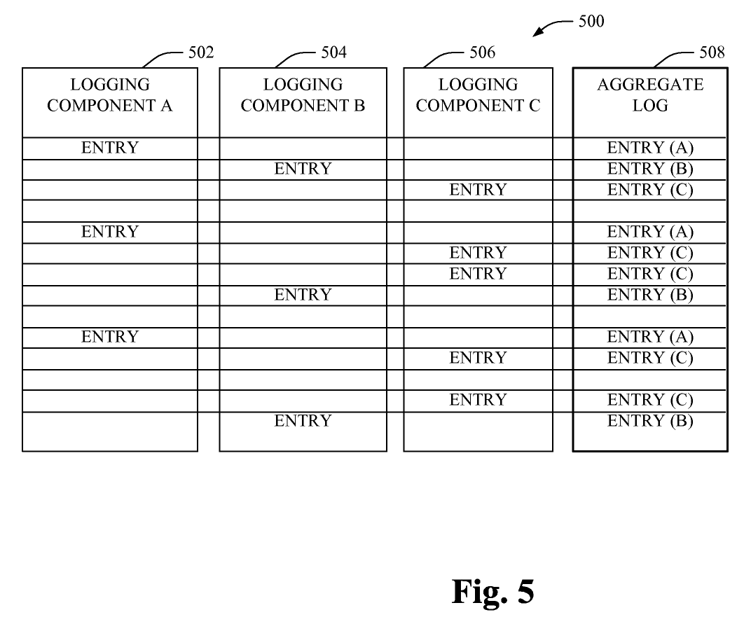

FIG. 5 illustrates a system 500 that aggregates data from multiple controllers and logging components. The system 500 illustrates further operation of the aggregation component described in detail supra. A plurality of logging components, A 502, B 504, and C 506, can reside on disparate controllers; the controllers can operate together or individually. The log entries can describe a related process, and can be grouped together by the aggregation component in an aggregate log 508. The information can be aggregated from any group of logging components, whether integral to a controller or otherwise. As depicted, the entries from the several logging components can be ordered according to time. The controllers that house the several logging components can be maintained on a synchronized timing schedule, and the entries can have a uniform timestamp convention. The aggregation component can re-order entries according to the timestamp information. Thus, the aggregate log 508 can comprise a compilation of the history of a group of controllers by providing a list of operations performed on the various controllers logged by the respective logging components in a clear easily reviewable manner. Changes made to one controller (e.g., recorded by logging component A 502) operating in concert with another controller may have no effect on the controller receiving the change, but produce a catastrophic result on another controller downstream (e.g., recorded in logging component B 504 or C 506), which can be recorded in the aggregate log 508 for review. The logged entries compiled into the aggregate log 508 can maintain their independence enabling simple extraction from the aggregate log 508 and grouping with a sub-set of the logs as desired.

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems and methods may include or consist of machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

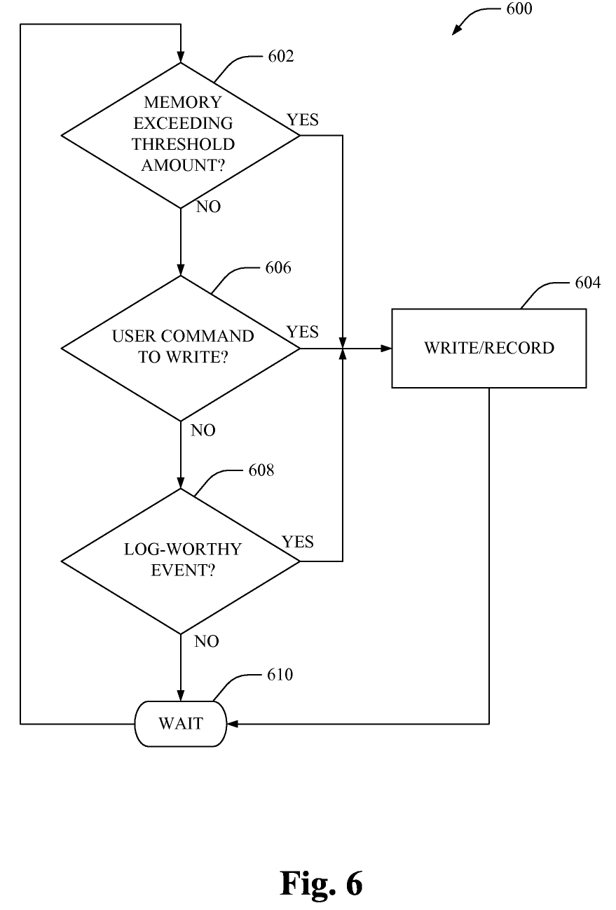

In view of the illustrative systems described supra, methodologies that can be implemented in accordance with the disclosed subject matter will be better appreciated with reference to the flow charts of FIGS. 6-8. While for purposes of simplicity of explanation, the methodology is shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodology described hereinafter.

FIG. 6 depicts a methodology 600 of logging information related to alterations made to a controller in accordance with an aspect of the subject innovation. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described.

As described above, a controller can contain local memory, as well as a logging component that facilitates recording information relating to alterations made to the controller, or any other related information. At 602, the local memory of the controller can be assessed to determine whether the amount of information stored in memory has reached a threshold level (which may be a percentage of capacity, e.g., 60%, 75%). The threshold can be any appropriate number as determined by the particulars of a given situation; different implementations of the methodology 600 can demand different thresholds. If the threshold has been reached or exceeded, at 604 the information can be recorded by a logging component. If memory has not reached the threshold, at 606 the presence of a user command to write to the log is detected. If the user has issued a command to write, the information is written to the log at 604. Moreover, an event that merits recording in the log may have occurred, and if so, the event can be recorded by the logging component at 604. An event that merits recording can comprise a major change to the system, a previously unknown user logging in for the first time, a firmware upgrade, or the like. Firmware upgrades can contain alterations to the log file structure, and therefore before the firmware upgrade log files in memory can be written to the log. The determination of a log-worthy event can be made using artificial intelligence techniques as described above. If no log-worthy event is detected, or after completing a log entry, at 610 the methodology can wait a given amount of time before repeating. The waiting period serves to reduce the effort required to perform the methodology, and can depend on the frequency of events or the workload of the system. An industrial process that runs continuously can have a shorter waiting period than another process where there is much downtime. In addition, artificial intelligence techniques can be employed to determine the appropriate waiting period by detecting recorded events and the intervals between events. It is to be appreciated that the events described at 602, 606, and 608, are merely illustrative, and not limiting in number or in scope. Also, the order in which the decisions are made as described herein is merely for illustration. The decisions can be made in any order, and some decisions may be omitted entirely or in part in a given iteration.

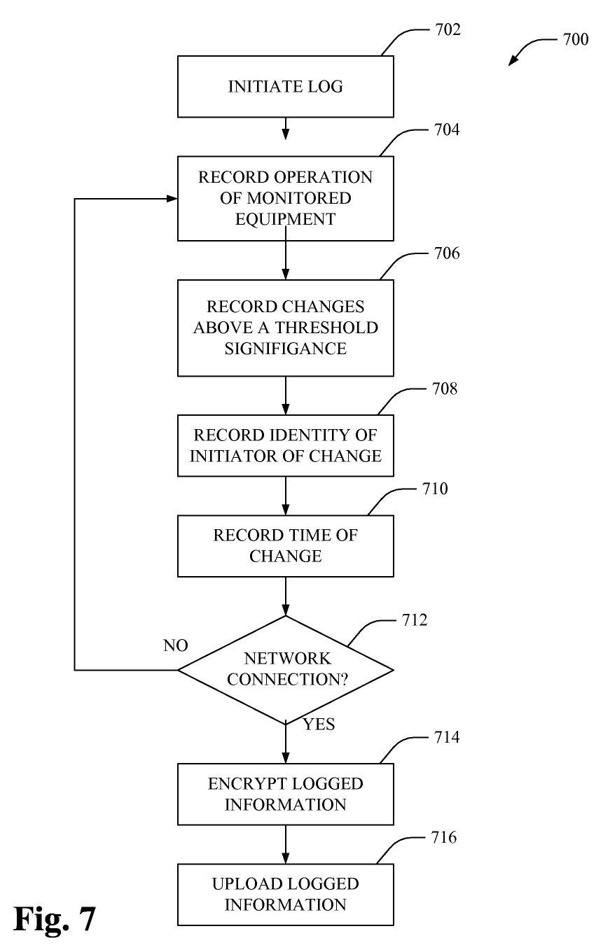

FIG. 7 depicts a methodology 700 that allows comprehensive, accurate information relating to an industrial application to be recorded. At reference numeral 702, a log is initiated by performing necessary acts to effectuate the log such as allocating memory, creating appropriate directories, setting up permissions and encryption, and naming the log. In an aspect, the log can be created by a logging component that can reside on a controller (or other equipment) that may have brief, intermittent communications opportunities. As an example, a small industrial process may employ only a handful of machines and have no network connecting the machines to each other or to a central communications hub. At reference numeral 704 the operation of the monitored equipment can be recorded. Depending on the circumstances of the operation, the logging component can log all actions of the equipment, or limit the log to landmark events, or events that are of a certain magnitude or can be predicted to have importance. Another type of event that can trigger a log entry is shown at reference numeral 706, changes to the equipment that are above a threshold significance. If, for example, a minor change that does not have a measurable effect on the product or the equipment is made, the log can omit an entry. On the other hand, a significant change (as defined on a case-by-case basis by a technician or supervisor) can be recorded. At reference numeral 708 the identity of the initiator of the change can be recorded. There are many reasons the identity of the operator is relevant, such as to assess liability, to improve operations, for training purposes, and the like. In addition to the identity of a human operator, some changes may be initiated by other equipment, in which case maintaining a trail back to the source of the change can prove valuable for troubleshooting a problem area. At reference numeral 710, the time of the event can be recorded.

The acts 704, 706, 708, and 710 can occur in any order and can repeat as dictated by the circumstances. At reference numeral 712, the presence of communication means can be sought. A network connection or other means of communication to another component or device capable of receiving a communication can act as communication means for the methodology 700. If there is no such communication means available, the process can repeat at numeral 704. If and when communication means are available, at reference numeral 714 the information can be encrypted or otherwise secured, and uploaded at reference numeral 716.

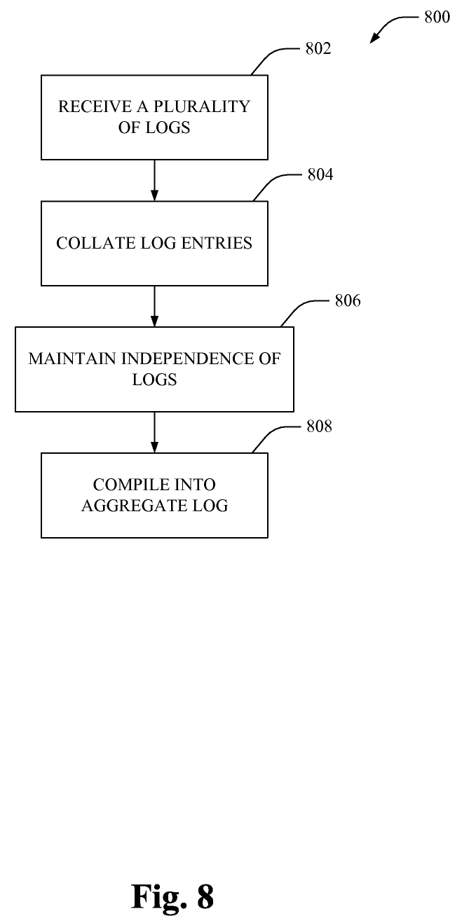

FIG. 8 represents a methodology 800 that enables aggregation and review of logged information. At reference numeral 802, a plurality of logs is received from a plurality of logging components. The logs can contain logged entries including descriptive information that facilitates synchronization of the entries, such as a timestamp. At reference numeral 804 the entries can be collated with the plurality of entries stored in the plurality of logs into an appropriate order, such as chronological order. However, at reference numeral 806, the independence of the logs and the entries of the logs can be maintained. That is, despite combining and collating the logged entries, the original information such as which log and which equipment in which the entries originated can be maintained. Therefore, it is a simple matter to select a group of logs and create a synchronized, collated list for the group, which may comprise less than all of the plurality of logs. Upon selecting the appropriate group of logs, the aggregate log is compiled at reference numeral 808. The aggregate log created according to methodology 800 provides for accurate, noise-free information that is easily reviewable.

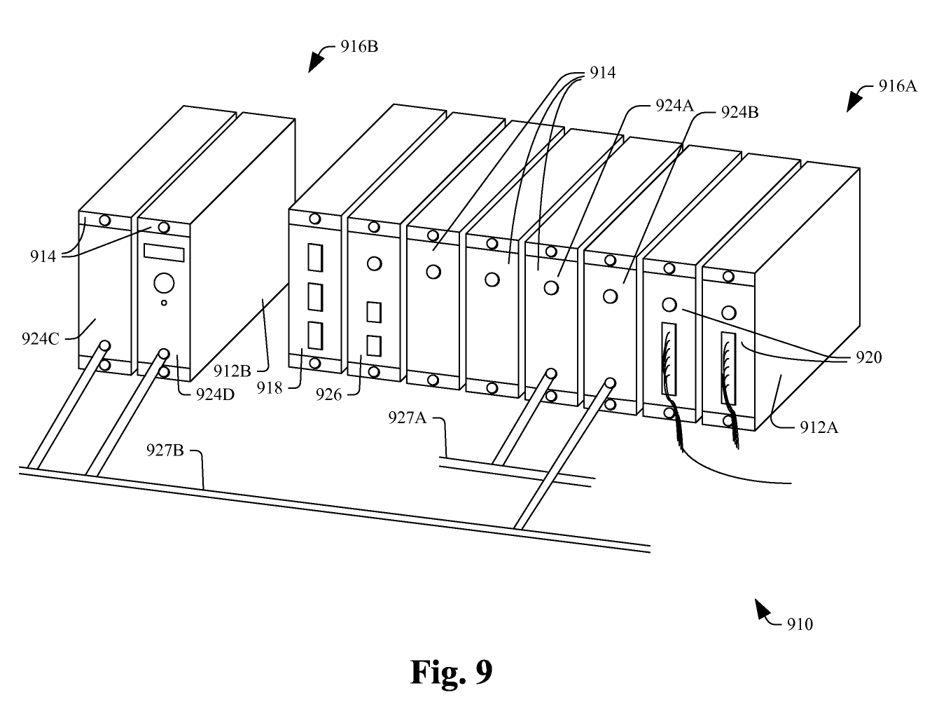

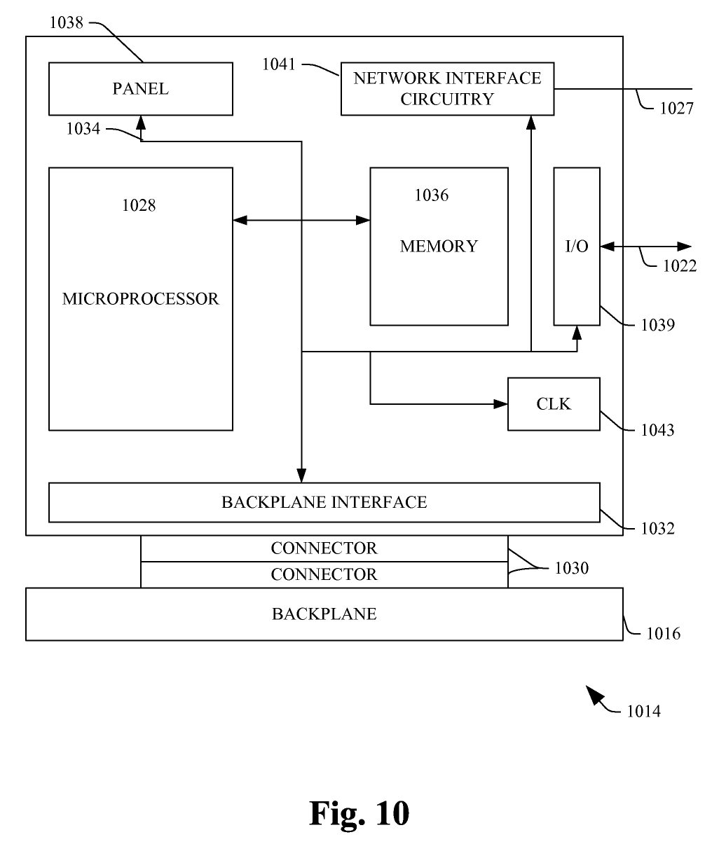

The methods and systems of the subject innovation can be employed in association with many forms of control systems. In order to provide context for the various applications in which the aspects of the innovation may be carried out, an exemplary control system is now illustrated and described with respect to FIGS. 9 and 10. However, it will be appreciated that the various aspects of the innovation may be employed in association with controllers and control systems other than those illustrated and described herein. A distributed industrial control system 910 suitable for use with the subject innovation provides a first and second rack 912A and 912B for holding a number of functional modules 914 electrically interconnected by backplanes 916A and 916B running along the rear of the racks 912A and 912B respectively. Each module 914 may be individually removed from the rack 912A or 912B thereby disconnecting it from its respective backplane 916 for repair or replacement and to allow custom configuration of the distributed system 910.

The modules 914 within the rack 912A may include, for example, a power supply module 918, a processor module 926, two communication modules 924A and 924B and two I/O modules 920. A power supply module 918 receives an external source of power (not shown) and provides regulated voltages to the other modules 914 by means of conductors on the backplane 916A. The I/O modules 920 provide an interface between inputs from, and outputs to external equipment (not shown) via cabling 922 attached to the I/O modules 920 at terminals on their front panels. The I/O modules 920 convert input signals on the cables 922 into digital words for transmission on the backplane 916A. The I/O modules 920 also convert other digital words from the backplane 916A to the necessary signal levels for control of equipment.

The communication modules 924A and 924B provide a similar interface between the backplane 916A and one of two external high speed communication networks 927A and 927B. The high speed communication networks 927A and 927B may connect with other modules 914 or with remote racks of I/O modules 920, controller configuration tools or systems, or the like. In the example illustrated in FIG. 9, the high speed communication network 927A connects with backplane 916A via the communication module 924A, whereas the high speed communication network 927B connects the communication module 924B with communication modules 924C and 924D in rack 912B. The processor module 926 processes information provided by the communication modules 924A and 924B and the I/O modules 920 according to a stored control program or routine, and provides output information to the communication module 924 and the I/O modules 920 in response to that stored program and received input messages.

Referring also to FIG. 10, each functional module 1014, is attached to the backplane 1016 by means of a separable electrical connector 1030 that permits the removal of the module 1014 from the backplane 1016 so that it may be replaced or repaired without disturbing the other modules 1014. The backplane 1016 provides the module 1014 with both power and a communication channel to the other modules 1014. Local communication with the other modules 1014 through the backplane 1016 is accomplished by means of a backplane interface 1032 which electrically connects the backplane 1016 through connector 1030. The backplane interface 1032 monitors messages on the backplane 1016 to identify those messages intended for the particular module 1014, based on a message address being part of the message and indicating the message destination. Messages received by the backplane interface 1032 are conveyed to an internal bus 1034 in the module 1014.

The internal bus 1034 joins the backplane interface 1032 with a memory 1036, a microprocessor 1028, front panel circuitry 1038, I/O interface circuitry 1039 (if the module is an I/O module 920) and communication network interface circuitry 1041 (if the module is a communication module 924). The microprocessor 1028 may be a general purpose microprocessor providing for the sequential execution of instructions included within the memory 1036 and the reading and writing of data to and from the memory 1036 and the other devices associated with the internal bus 1034. The microprocessor 1028 includes an internal clock circuit (not shown) providing the timing of the microprocessor 1028 but may also communicate with an external clock 1043 of improved precision. This clock 1043 may be a crystal controlled oscillator or other time standard including a radio link to an external time standard. The precision of the clock 1043 may be recorded in the memory 1036 as a quality factor. The panel circuitry 1038 includes status indication lights such as are well known in the art and manually operable switches such as for locking the module 1014 in the off state.

The memory 1036 may comprise control programs or routines executed by the microprocessor 1028 to provide control functions, as well as variables and data necessary for the execution of those programs or routines. For I/O modules 920, the memory 1036 may also include an I/O table holding the current state of inputs and outputs received from and transmitted to the industrial controller 910 via the I/O modules 920. The module 1014 may be adapted to perform the various methodologies of the innovation, via hardware configuration techniques and/or by software programming techniques.

Although the innovation has been shown and described with respect to certain illustrated aspects, it will be appreciated that equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure, which performs the function in the herein illustrated exemplary aspects of the innovation. In this regard, it will also be recognized that the innovation includes a system as well as a computer-readable medium having computer-executable instructions for performing the acts and/or events of the various methods of the innovation.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A controller system, comprising:
a logging component that records data related to an industrial process; and
an aggregation component that receives the data, and based in part thereon, compiles information into an aggregate log.

2. The system of claim 1, the logging component is part of a controller associated with the controller system.

3. The system of claim 1, the logging component and the aggregation component are in periodic communication.

4. The system of claim 1, the logging component further comprising an internal storage device.

5. The system of claim 1, further comprising an artificial intelligence component that analyzes a detectable event, and infers whether to record the event.

6. The system of claim 1, the logging component with encryption capabilities.

7. The system of claim 1, further comprising a security component that protects the logged information from compromise.

8. The system of claim 7, the security component at least one of resists or records unauthorized attempts to access the aggregate log.

9. The system of claim 1, further comprising a tracking component receives information recorded by the logging component.

10. The system of claim 9, the tracking component restores an altered setting to at least one previous state.

11. A method of recording industrial data comprising:
recording an event occurring with an industrial controller;
recording contextual information associated with the event; and
aggregating recorded event information and the contextual information into an aggregate log.

12. The method of claim 11, recording the event comprises recording an alteration to a setting of the industrial controller.

13. The method of claim 11, recording contextual information indicating that the event merits recording as defined by an operator.

14. The method of claim 13, further comprising deeming the event significant by artificial intelligence techniques.

15. The method of claim 11 further comprising inferring periods to log data.

16. The method of claim 11 further comprising re-ordering recorded data.

17. The method of claim 11, further comprising maintaining independence of the recorded events and permitting selective aggregation of recorded events.

18. The method of claim 11, further comprising recording the contextual information comprising at least one of identity of the initiator of the event, status of the initiator of the event, or location of the initiator of the event.

19. A logging and aggregation system, comprising:
means for determining contextual information related to modifications of an industrial controller; and
means for aggregating recorded modifications and contextual information associated therewith.

20. The system of claim 19, further comprising means for securing the information from compromise.
